(19) United States
(12) Patent Application Publication
(10) Pub. No.: US 2005/0182910 A1
(43) Pub. Date: Aug. 18, 2005

(54) Method and system for adding redundancy to a continuous data protection system

(75) Inventors: Roger Keith Stager, Livermore, CA (US); Donald Alvin Trimmer, Livermore, CA (US); Pawan Saxena, Pleasanton, CA (US); Craig Anthony Johnston, Livermore, CA (US); Yafen Peggy Chang, Fremont, CA (US); Rico Blaser, San Francisco, CA (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: Alacritus, Inc., Pleasanton, CA (US)

(21) Appl. No.: 11/051,862

(22) Filed: Feb. 4, 2005

Related U.S. Application Data
(60) Provisional application No. 60/541,626, filed on Feb. 4, 2004.
(60) Provisional application No. 60/542,011, filed on Feb. 5, 2004.

(51) Int. Cl. G06F 12/16

(52) U.S. Cl. 711/162; 711/159

(57) ABSTRACT

A method for adding redundancy to a continuous data protection system begins by taking a snapshot of a primary volume at a specific point in time, in accordance with a retention policy. The snapshot is stored on a secondary volume, and the snapshot is cloned and stored on a third volume. The cloned snapshot is eventually expired according to a cloning policy.

### CROSS REFERENCE TO RELATED APPLICATIONS

This application claims priority from U.S. Provisional Application No. 60/541,626, filed on Feb. 4, 2004; and U.S. Provisional Application No. 60/542,011, filed on Feb. 5, 2004, which are incorporated by reference as if fully set forth herein.

### FIELD OF INVENTION

The present invention relates generally to continuous data protection, and more particularly, to a method and system for adding redundancy to a continuous data protection system.

### BACKGROUND

Hardware redundancy schemes have traditionally been used in enterprise environments to protect against component failures. Redundant arrays of independent disks (RAID) have been implemented successfully to assure continued access to data even in the event of one or more media failures (depending on the RAID Level). Unfortunately, hardware redundancy schemes are ineffective in dealing with logical data loss or corruption. For example, an accidental file deletion or virus infection is automatically replicated to all of the redundant hardware components and can neither be prevented nor recovered from by such technologies. To overcome this problem, backup technologies have traditionally been deployed to retain multiple versions of a production system over time. This allowed administrators to restore previous versions of data and to recover from data corruption.

Backup copies are generally policy-based, are tied to a periodic schedule, and reflect the state of a primary volume (i.e., a protected volume) at the particular point in time that is captured. Because backups are not made on a continuous basis, there will be some data loss during the restoration, resulting from a gap between the time when the backup was performed and the restore point that is required. This gap can be significant in typical environments where backups are only performed once per day. In a mission-critical setting, such a data loss can be catastrophic. Beyond the potential data loss, restoring a primary volume from a backup system can be complicated and often takes many hours to complete. This additional downtime further exacerbates the problems associated with a logical data loss.

The traditional process of backing up data to tape media is time driven and time dependent. That is, a backup process typically is run at regular intervals and covers a certain period of time. For example, a full system backup may be run once a week on a weekend, and incremental backups may be run every weekday during an overnight backup window that starts after the close of business and ends before the next business day. These individual backups are then saved for a predetermined period of time, according to a retention policy. In order to conserve tape media and storage space, older backups are gradually faded out and replaced by newer backups. Further to the above example, after a full weekly backup is completed, the daily incremental backups for the preceding week may be discarded, and each weekly backup may be maintained for a few months, to be replaced by monthly backups. The daily backups are typically not all discarded on the same day. Instead, the Monday backup set is overwritten on Monday, the Tuesday backup set is overwritten on Tuesday, and so on. This ensures that a backup set is available that is within eight business hours of any corruption that may have occurred in the past week.

Despite frequent hardware failures and the necessity of ongoing maintenance and tuning, the backup creation process can be automated, while restoring data from a backup remains a manual and time-critical process. First, the appropriate backup tapes need to be located, including the latest full backup and any incremental backups made since the last full backup. In the event that only a partial restoration is required, locating the appropriate backup tape can take just as long. Once the backup tapes are located, they must be restored to the primary volume. Even under the best of circumstances, this type of backup and restore process cannot guarantee high availability of data.

Another type of data protection involves making point in time (PIT) copies of data. A first type of PIT copy is a hardware-based PIT copy, which is a mirror of the primary volume onto a secondary volume. The main drawbacks to a hardware-based PIT copy are that the data ages quickly and that each copy takes up as much disk space as the primary volume. A software-based PIT, typically called a “snapshot,” is a “picture” of a volume at the block level or a file system at the operating system level. Various types of software-based PITs exist, and most are tied to a particular platform, operating system, or file system. These snapshots also have drawbacks, including occupying additional space on the primary volume, rapid aging, and possible dependencies on data stored on the primary volume wherein data corruption on the primary volume leads to corruption of the snapshot. In addition, snapshot systems generally do not offer the flexibility in scheduling and expiring snapshots that backup software provides.

While both hardware-based and software-based PIT techniques reduce the dependency on the backup window, they still require the traditional tape-based backup and restore process to move data from disk to tape media and to manage the different versions of data. This dependency on legacy backup applications and processes is a significant drawback of these technologies. Furthermore, like traditional tape-based backup and restore processes, PIT copies are made at discrete moments in time, thereby limiting any restores that are performed to the points in time at which PIT copies have been made.

A need therefore exists for a system that combines the advantages of tape-based systems with the advantages of snapshot systems and eliminates the limitations described above.

### SUMMARY

A method for adding redundancy to a continuous data protection system begins by taking a snapshot of a primary volume at a specific point in time, in accordance with a retention policy. The snapshot is stored on a secondary volume, and the snapshot is cloned and stored on a third volume. The cloned snapshot is eventually expired according to a cloning policy.

A system for adding redundancy to a continuous data protection system includes snapshot means, storing means, cloning means, and expiring means. The snapshot means takes a snapshot of a primary volume at a specific point in time. The storing means stores the snapshot on a secondary volume. The cloning means clones the snapshot and stores the clone on a third volume. The expiring means expires the cloned snapshot according to a cloning policy.

A method for managing a recovery point in a continuous data protection system begins by setting a retention policy and a cloning policy. A snapshot of a primary volume is taken according to the retention policy, the snapshot providing a recovery point on the primary volume. The snapshot is stored on a secondary volume and is expired according to the retention policy. A clone of the snapshot is created according to the cloning policy and is stored on a third volume. The cloned snapshot is expired according to the cloning policy.

A system for managing a recovery point in a continuous data, protection system includes snapshot means for taking a snapshot of a primary volume, the snapshot means being controlled by a first policy means. A first storing means stores the snapshot on a secondary volume. A first expiring means expires snapshot, the first expiring means being controlled by the first policy means. A cloning means creates a clone of the snapshot, the cloning means being controlled by a second policy means. A second storing means stores the cloned snapshot on a third volume. A second expiring means expires the cloned snapshot, the second expiring means being controlled by the second policy means.

A system for continuous data protection includes a host computer and a first volume connected to the host computer, the first volume containing data to be protected. A first data protection system is connected to the host computer. A second volume is connected to the first data protection system, the second volume being a protected version of the first volume. A second data protection system communicates with the first data protection system and a third volume is connected to the second data protection system. The third volume is a copy of the second volume.

### BRIEF DESCRIPTION OF THE DRAWINGS

A more detailed understanding of the invention may be had from the following description of a preferred embodiment, given by way of example, and to be understood in conjunction with the accompanying drawings, wherein:

FIGS. 1A-1C are block diagrams showing a continuous data protection environment in accordance with the present invention;

FIG. 2 is an example of a delta map in accordance with the present invention;

FIG. 3 is a diagram illustrating a retention policy for the fading out of snapshots in accordance with the present invention;

FIG. 4 is a flowchart showing the operation of a retention policy in accordance with the present invention;

FIG. 5 is a flowchart showing the operation of a cloning policy in accordance with the present invention;

FIG. 6A is a block diagram of a continuous data protection system including local cloning;

FIG. 6B is a block diagram of a continuous data protection system including remote cloning; and

FIG. 6C is a block diagram of a continuous data protection system including remote cloning with a bunker appliance.

### DETAILED DESCRIPTION OF THE PREFERRED EMBODIMENTS

In the present invention, data is backed up continuously, allowing system administrators to pause, rewind, and replay live enterprise data streams. This moves the traditional backup methodologies into a continuous background process in which policies automatically manage the lifecycle of many generations of restore images.

System Construction

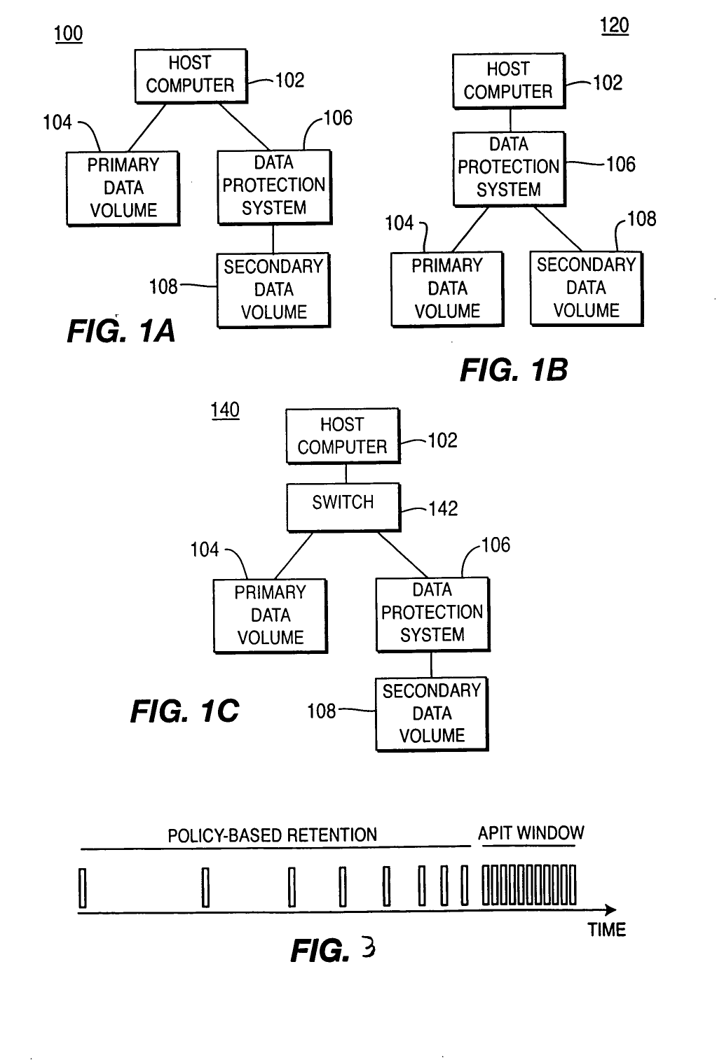

FIG. 1A shows a preferred embodiment of a protected computer system 100 constructed in accordance with the present invention. A host computer 102 is connected directly to a primary data volume 104 (the primary data volume may also be referred to as the protected volume) and to a data protection system 106. The data protection system 106 manages a secondary data volume 108. The construction of the system 100 minimizes the lag time by writing directly to the primary data volume 104 and permits the data protection system 106 to focus exclusively on managing the secondary data volume 108. The management of the volumes is preferably performed using a volume manager.

A volume manager is a software module that runs on a server or intelligent storage switch to manage storage resources. Typical volume managers have the ability to aggregate blocks from multiple different physical disks into one or more virtual volumes. Applications are not aware that they are actually writing to segments of many different disks because they are presented with one large, contiguous volume. In addition to block aggregation, volume managers usually also offer software RAID functionality. For example, they are able to split the segments of the different volumes into two groups, where one group is a mirror of the other group. This is, in a preferred embodiment, the feature that the data protection system is taking advantage of when the present invention is implemented as shown in FIG. 1A. In many environments, the volume manager or host-based driver already mirrors the writes to two distinct different primary volumes for redundancy in case of a hardware failure. The present invention is configured as a tertiary mirror target in this scenario, such that the volume manager or host-based driver also sends copies of all writes to the data protection system.

It is noted that the primary data volume 104 and the secondary data volume 108 can be any type of data storage, including, but not limited to, a single disk, a disk array (such as a RAID), or a storage area network (SAN). The main difference between the primary data volume 104 and the secondary data volume 108 lies in the structure of the data stored at each location, as will be explained in detail below. It is noted that there may also be differences in terms of the technologies that are used. The primary volume 104 is typically an expensive, fast, and highly available storage subsystem, whereas the secondary volume 108 is typically cost-effective, high capacity, and comparatively slow (for example, ATA/SATA disks). Normally, the slower secondary volume cannot be used as a synchronous mirror to the high-performance primary volume, because the slower response time will have an adverse impact on the overall system performance.

The data protection system 106, however, is optimized to keep up with high-performance primary volumes. These optimizations are described in more detail below, but at a high level, random writes to the primary volume 104 are processed sequentially on the secondary volume 108. Sequential writes improve both the cache behavior and the actual volume performance of the secondary volume 108. In addition, it is possible to aggregate multiple sequential writes on the secondary volume 108, whereas this is not possible with the random writes to the primary volume 104. The present invention does not require writes to the data protection system 106 to be synchronous. However, even in the case of an asynchronous mirror, minimizing latencies is important.

FIG. 1B shows an alternate embodiment of a protected computer system 120 constructed in accordance with the present invention. The host computer 102 is directly connected to the data protection system 106, which manages both the primary data volume 104 and the secondary data volume 108. The system 120 is likely slower than the system 100 described above, because the data protection system 106 must manage both the primary data volume 104 and the secondary data volume 108. This results in a higher latency for writes to the primary volume 104 in the system 120 and lowers the available bandwidth for use. Additionally, the introduction of a new component into the primary data path is undesirable because of reliability concerns.

FIG. 1C shows another alternate embodiment of a protected computer system 140 constructed in accordance with the present invention. The host computer 102 is connected to an intelligent switch 142. The switch 142 is connected to the primary data volume 104 and the data protection system 106, which in turn manages the secondary data volume 108. The switch 142 includes the ability to host applications and contains some of the functionality of the data protection system 106 in hardware, to assist in reducing system latency and improve bandwidth.

It is noted that the data protection system 106 operates in the same manner, regardless of the particular construction of the protected computer system 100, 120, 140. The major difference between these deployment options is the manner and place in which a copy of each write is obtained. To those skilled in the art it is evident that other embodiments, such as the cooperation between a switch platform and an external server, are also feasible.

Conceptual Overview

To facilitate further discussion, it is necessary to explain some fundamental concepts associated with a continuous data protection system constructed in accordance with the present invention. In practice, certain applications require continuous data protection with a block-by-block granularity, for example, to rewind individual transactions. However, the period in which such fine granularity is required is generally short (for example, two days), which is why the system can be configured to fade out data over time. The present invention discloses data structures and methods to manage this process automatically.

The present invention keeps a log of every write made to a primary volume (a “write log”) by duplicating each write and directing the copy to a cost-effective secondary volume in a sequential fashion. The resulting write log on the secondary volume can then be played back one write at a time to recover the state of the primary volume at any previous point in time. Replaying the write log one write at a time is very time consuming, particularly if a large amount of write activity has occurred since the creation of the write log. In typical recovery scenarios, it is necessary to examine how the primary volume looked like at multiple points in time before deciding which point to recover to. For example, consider a system that was infected by a virus. In order to recover from the virus, it is necessary to examine the primary volume as it was at different points in time to find the latest recovery point where the system was not yet infected by the virus. Additional data structures are needed to efficiently compare multiple potential recovery points.

Delta Maps

Delta maps provide a mechanism to efficiently recover the primary volume as it was at a particular point in time without the need to replay the write log in its entirety, one write at a time. In particular, delta maps are data structures that keep track of data changes between two points in time. These data structures can then be used to selectively play back portions of the write log such that the resulting point-in-time image is the same as if the log were played back one write at a time, starting at the beginning of the log.

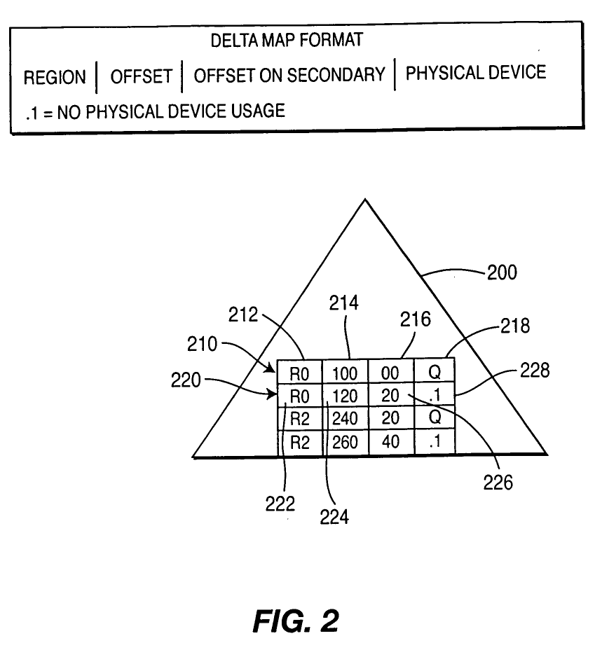

FIG. 2 shows a delta map 200 constructed in accordance with the present invention. While the format shown in FIG. 2 is preferred, any format containing similar information may be used. For each write to a primary volume, a duplicate write is made, in sequential order, to a secondary volume. To create a mapping between the two volumes, it is preferable to have an originating entry and a terminating entry for each write. The originating entry includes information regarding the origination of a write, while the terminating entry includes information regarding the termination of the write.

As shown in delta map 200, row 210 is an originating entry and row 220 is a terminating entry. Row 210 includes a field 212 for specifying the region of a primary volume where the first block was written, a field 214 for specifying the block offset in the region of the primary volume where the write begins, a field 216 for specifying where on the secondary volume the duplicate write (i.e., the copy of the primary volume write) begins, and a field 218 for specifying the physical device (the physical volume or disk identification) used to initiate the write. Row 220 includes a field 222 for specifying the region of the primary volume where the last block was written, a field 224 for specifying the block offset in the region of the primary volume where the write ends, a field 226 for specifying the where on the secondary volume the duplicate write ends, and a field 228. While fields 226 and 228 are provided in a terminating entry such as row 220, it is noted that field 226 is optional because this value can be calculated by subtracting the offsets of the originating entry and the terminating entry (field 226=(field 224−field 214)+field 216), and field 228 is not necessary since there is no physical device usage associated with termination of a write.

In a preferred embodiment, as explained above, each delta map contains a list of all blocks that were changed during the particular time period to which the delta map corresponds. That is, each delta map specifies a block region on the primary volume, the offset on the primary volume, and physical device information. It is noted, however, that other fields or a completely different mapping format may be used while still achieving the same functionality. For example, instead of dividing the primary volume into block regions, a bitmap could be kept, representing every block on the primary volume. Once the retention policy (which is set purely according to operator preference) no longer requires the restore granularity to include a certain time period, corresponding blocks are freed up, with the exception of any blocks that may still be necessary to restore to later recovery points. Once a particular delta map expires, its block list is returned to the appropriate block allocator for re-use.

Delta maps are initially created from the write log using a map engine, and can be created in real-time, after a certain number of writes, or according to a time interval. It is noted that these are examples of ways to trigger the creation of a delta map, and that one skilled in the art could devise various other triggers. Additional delta maps may also be created as a result of a merge process (called “merged delta maps”) and may be created to optimize the access and restore process. The delta maps are stored on the secondary volume and contain a mapping of the primary address space to the secondary address space. The mapping is kept in sorted order based on the primary address space.

One significant benefit of merging delta maps is a reduction in the number of delta map entries that are required. For example, when there are two writes that are adjacent to each other on the primary volume, the terminating entry for the first write can be eliminated from the merged delta map, since its location is the same as the originating entry for the second write. The delta maps and the structures created by merging maps reduces the amount of overhead required in maintaining the mapping between the primary and secondary volumes.

Data Recovery

Data is stored in a block format, and delta maps can be merged to reconstruct the full primary volume as it looked like at a particular point in time. Users need to be able to access this new volume seamlessly from their current servers. There are two ways to accomplish this at a block level. The first way is to mount the new volume (representing the primary volume at a previous point in time) to the server. The problem with this approach is that it can be a relatively complex configuration task, especially since the operation needs to be performed under time pressure and during a crisis situation, i.e., during a system outage. However, some systems now support dynamic addition and removal of volumes, so this may not be a concern in some situations.

The second way to access the recovered primary volume is to treat the recovered volume as a piece of removable media (e.g., a CD), that is inserted into a shared removable media drive. In order to properly recover data from the primary volume at a previous point in time, an image of the primary volume is loaded onto a location on the network, each location having a separate identification known as a logical unit number (LUN). This procedure is discussed in U.S. patent application Ser. No. 10/772,017, filed Feb. 4, 2004, which is incorporated by reference as if fully set forth herein.

Retention Policy

FIG. 3 shows a diagram of a retention policy used in connection with fading out the APIT snapshots over time. The retention policy consists of several parts. One part is used to decide how large the APIT window is and another part decides when to take scheduled snapshots and for how long to retain them. Each scheduled snapshot consists of all the changes up to that point in time; over longer periods of time, each scheduled snapshot will contain the changes covering a correspondingly larger period of time, with the granularity of more frequent snapshots being unnecessary.

It is noted that outside the APIT window (the left portion of FIG. 3), some data will be phased out (shown by the gaps on the left portion of FIG. 3). Deciding which data to phase out is similar to a typical tape rotation scheme. A policy is entered by the user that decides to retain data that was recorded, for example, at each minute boundary. It is also noted that the present invention provides versioning capabilities with respect to snapshots (i.e., file catalogs, scheduling capabilities, etc.) as well as the ability to establish compound/aggregate policies, etc. when outside an APIT window.

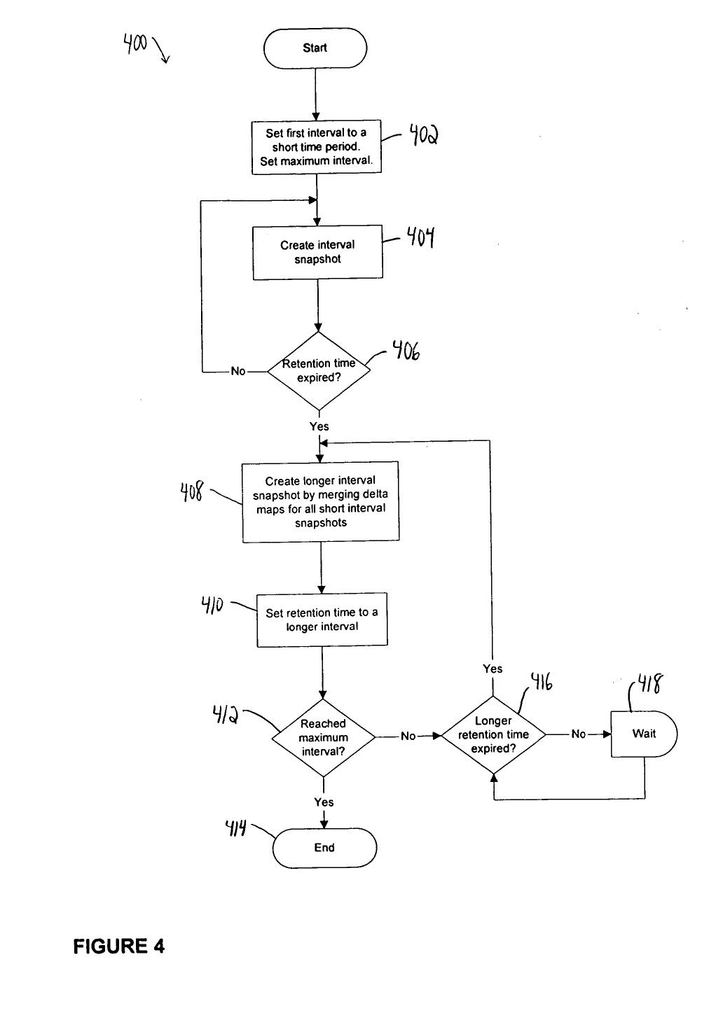

Referring now to FIG. 4, there is shown a method 400 for implementing a retention policy outside of an APIT window in a continuous data protection system. The method 400 begins by setting a first time interval to a relatively short period (e.g., one minute) and setting a maximum time interval (e.g., one year; step 402). A snapshot is created for the short time interval (step 404). A short time interval snapshot is one of many snapshots taken at predetermined intervals, to provide a desired level of granularity in the data stored on the secondary volume. Typically the predetermined intervals are set such that there is a high level of granularity (i.e., many snapshots from which to create PIT maps for purposes of a restore) on the secondary volume. The short time interval snapshots are typically used where the data is still relatively fresh and it is likely that changes in the primary volume that occurred between small intervals of time may be needed in the event of a failure.

The older the data is, however, the less likely it is that snapshots between small time intervals will be needed (i.e., less granularity is required on the secondary volume). It is then determined whether the short retention time has expired for any of the data (step 406). If the retention time has not expired, the method 400 cycles back to step 404 where additional short time interval snapshots are created. If the retention time for the snapshot has expired (step 406), then longer interval snapshots may be created by merging delta maps for all short interval snapshots (step 408). The retention time is then set to a longer interval (step 410). If the maximum time interval has been reached (step 412), then the method terminates (step 414). If the maximum time interval has not been reached (step 412), then a determination is made whether the longer time interval has expired (step 416). If the longer retention time interval has expired, then the method continues with step 408. If the longer retention time interval has not expired (step 416), then the method waits (step 418) before again checking whether the longer time interval has expired (step 416).

A similar method (not shown) uses a number-based policy that states how many snapshots are kept for each retention time frame (e.g., one minute, one hour, etc.). For example, instead of stating for how long the hourly snapshots are retained or how much disk space should be used to store hourly snapshots, the number-based policy states that at least ten hourly snapshots are kept at any given time. Under this type of policy, the oldest snapshot is discarded when a new snapshot is taken, creating a sliding window of the snapshot coverage in terms of time. The size of the window is determined by the policy settings made by the user.

Duplicating Snapshots

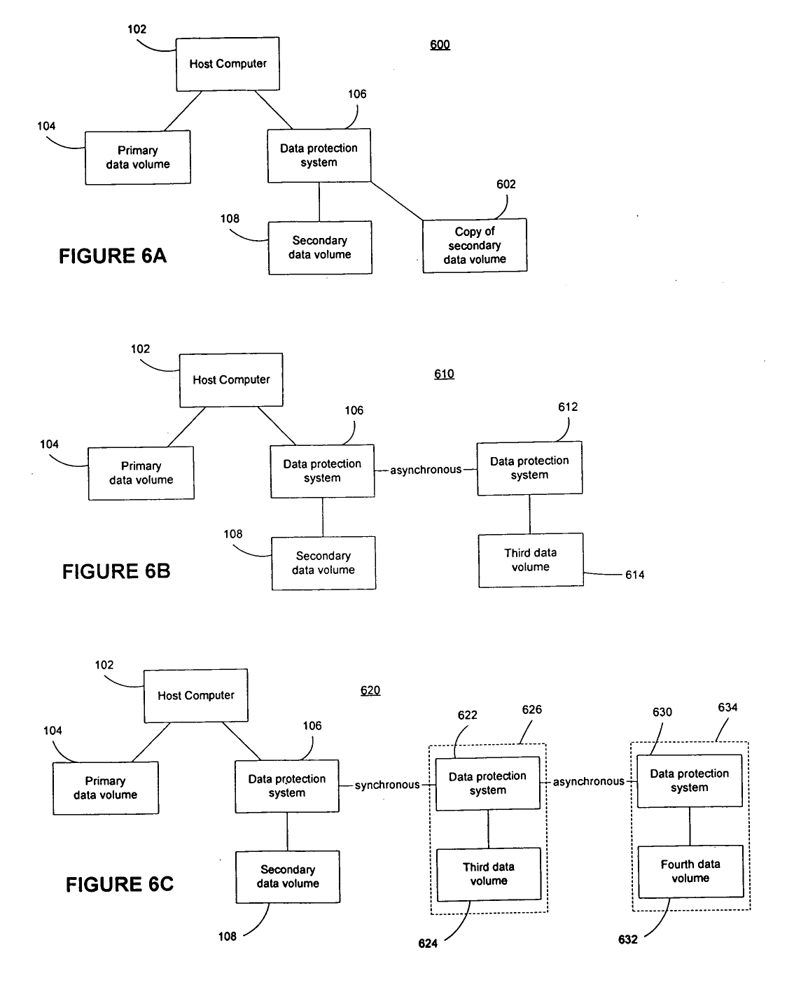

The present invention also supports snapshot clones (including both single clones and double clones) and fault zones. These features extend the data retention policies in an important way. In addition to defining the retention period of each snapshot, cloning allows users to specify the number of physical copies of the data blocks that make up each snapshot that are retained. In other words, a cloning policy defines the amount of redundancy that is used to store each snapshot. Fault zones relate to a group of storage devices that share a common point of failure, for example, all of the volumes connected to a single RAID controller. Fault zones will be discussed in greater detail in connection with FIG. 6.

The benefit of retaining multiple copies of certain snapshots is related to the continuous data protection system's journaling structures. Since each write is only retained in one physical location, multiple snapshots typically depend on the same physical data blocks. Future snapshots always depend upon previous data blocks, so if a block has not changed, it will always be in the snapshot. A hardware failure leading to the corruption of a single data block may result in the partial corruption of an entire series of snapshots (from the time the data block becomes corrupted and forward). This behavior is undesirable, and can affect systems in which only metadata is used to create the snapshot and where there are not multiple copies of the same data.

One way to eliminate such failure conditions is to duplicate (clone) every write on the secondary volume to two or more independent physical devices. This approach is effective, but also inefficient because it requires multiple times the storage space. A more efficient alternative is to duplicate data selectively in a trade-off between the recovery granularity in the case of a failure and the required storage capacity. Is it desirable to only move metadata structures for purposes of duplication, but to also occasionally make multiple copies of the same data blocks as additional insurance against media failure.

For example, a cloning policy can be configured where hourly snapshots are not duplicated, but daily snapshots are duplicated to an independent physical disk subsystem. In the unlikely event of a hardware failure causing a corruption of a data block on the secondary disk that consequently impacts a chain of hourly snapshots, the cloned daily snapshots can be used to bound the window of error from both sides to a 24-hour period. Based upon the user's preferences in setting the cloning policy, the user can choose a point between the two extremes (moving only metadata structures and retaining multiple copies of every snapshot), to set the desired level of redundancy. This permits the user to independently manage the recovery points and the redundancy with which each recovery point is kept.

The user can select the number clones to be made, the frequency of the cloning, and the granularity for retaining the clones. This is conceptually different from existing data protection systems, in which the user is bound by the policies predetermined by the data protection system with minimal (if any) input from the user regarding the number of the backups or the frequency of their creation. The retention policy incorporates the cloning policy, so that from an overall perspective, the user selects which points in time to take snapshots of, and for each snapshot, how many copies are to be cloned onto independent disks.

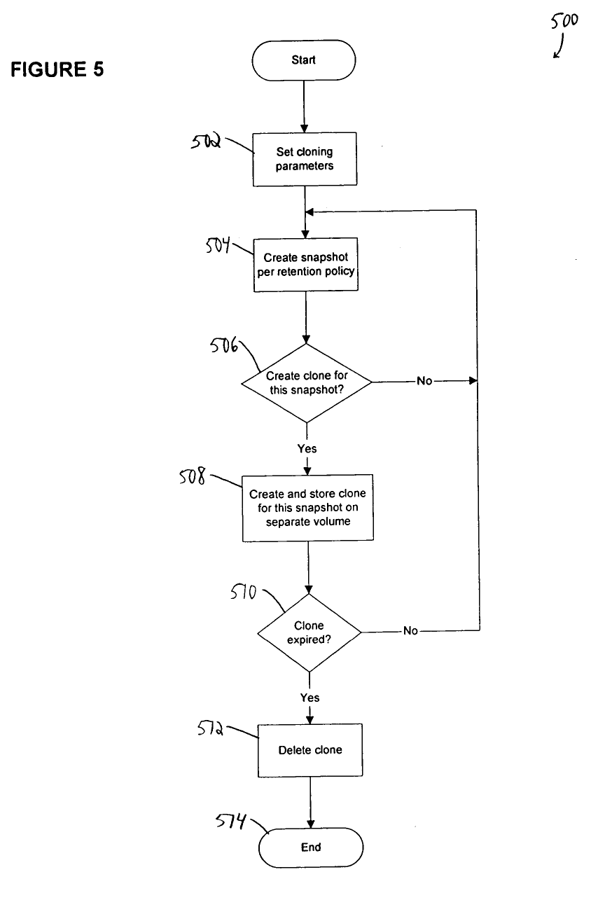

A method 500 for implementing a cloning policy in accordance with the present invention is shown in FIG. 5. The method 500 begins by setting the cloning parameters, including the number clones to be made, the frequency of the cloning, and the granularity for retaining the clones (step 502). A snapshot is then created, as set out in the retention policy and as described above (step 504). A determination is made whether a clone of the current snapshot is to be created (step 506). It is noted that the method 500 operates in the same manner whether one clone or multiple clones are created.

If no clones of the current snapshot are to be created, then the method returns to step 504. If a clone of the current snapshot is to be created (step 506), then the clone is created and stored on a separate volume (step 508). After the clone has been stored, a determination at some later time is made whether the clone has expired (step 510). If the clone has not expired, then the method returns to step 504. If the clone has expired, then the clone is deleted (step 512) and the method terminates (step 514).

The redundancy is used to store each snapshot, which as previously described, is an access point to the secondary storage. If the access point (i.e., snapshot) becomes corrupted, then a restore to that PIT cannot occur due to the corruption of the snapshot. Cloning alleviates this problem by copying the data blocks of a snapshot and the metadata relating to that snapshot. If the primary snapshot becomes corrupted, the user can still restore to that same PIT by accessing the cloned snapshot. Cloning does not create additional points in time to restore to, but makes a specific PIT more reliable for restoring to by storing multiple redundant copies of the data as it was at a specific PIT.

Clones of all the snapshots are generally not stored, because doing so would require too much disk space. Clones can expire at the same time as the original snapshot, or can expire at times unrelated to the time of the original snapshot. Expiring the clones at the same time as the original snapshot is related to the granularity for retaining the original snapshots; there is no need to keep a clone of a snapshot that has been phased out based upon the granularity set in the retention policy.

The redundant data blocks are kept on separate disk subsystems or LUNs. Because only a subset of snapshots are duplicated, it is noted that the corresponding delta maps for the duplicated snapshots are different as well. For example, if a given retention policy specifies that M hourly snapshots and N daily snapshots are retained during a certain time period (where M>N>0), and the data blocks making up the N daily snapshots are cloned, then the differences in the delta maps are quite apparent. In the original snapshot sequence, the delta maps (and the corresponding blocks) are kept between each hourly snapshot, whereas the cloned snapshots only contain delta maps and data blocks that specify the changes between the daily snapshots, which is essentially a merged view of the original delta map chain. By storing the hourly snapshots without redundancy, there are multiple delta maps, but the daily snapshot is only cloned once a day. Only the data blocks and the delta maps that get copied correspond to what would happen if all the shorter interval delta maps were merged together. The delta map relates to changes between the clones, so it would be a large delta map including all of the changes.

This difference, however, can be useful in the case where a delta map structure becomes corrupted, because it is possible to fix the corrupted structure from the cloned instance and vice versa. The ability to fix corrupted structures depends upon the relative granularity that is stored normally and the granularity of the clones. If the granularity is the same, then any corrupted structures can be fixed in either direction. But where the granularity differs, it is only possible to make corrections from the finer granularity structure to the wider granularity structure. So in the example above, only the cloned daily snapshots can be repaired, because the hourly snapshots are normally taken.

Fault Zones and Remote Clones

A fault zone is a group of storage devices that share a common point of failure. As used in the present invention, fault zones are arranged in a hierarchical structure, for example (from smaller to larger fault zones), RAID controller/disk, chassis/appliance, data center, and campus. It is noted that these fault zones are exemplary, and that one skilled in the art can create fault zones of finer or wider granularity. If an event occurs to disrupt the data protection system, all volumes within the fault zone will be similarly affected. For example, if the fault zone is a data center and there is a power failure, all devices in the data center will be inoperable.

In order to improve system tolerance to potential failures, one of the redundant clones should be stored outside of the fault zone of the secondary data volume in as a distant location as possible, from a fault zone perspective. Continuing the above example, if the fault zone is a data center, then one of the clones should be stored in a different data center or a different campus. There is a trade-off involved in creating the system with remote clones between the desire to retain remote clones and the costs associated with establishing a remote site and transferring the clones to the remote site. The remote site should be selected such that there is some level of isolation in terms of fault zones between the secondary data volume and any clones.

When a snapshot is copied to a remote site, the delta maps are copied from the local secondary data volume to the remote secondary data volume. If this transfer fails (e.g., a system interruption occurs before the transfer is completed), it can be restarted by resending the delta maps and associated data. In addition, the entire write log, including time stamps, can be transferred to the remote site. In this case, the transfer can be performed asynchronously (i.e., not in real time), which is a benefit since the write log can be a fairly large file.

FIGS. 6A-6C show different embodiments of a continuous data protection system including storage for clones. FIG. 6A shows a system 600 which provides local clone storage. It is noted that the parts of the system 600 that correspond to the system 100 described above have been given like reference numerals. The system 600 includes the host computer 102 connected directly to the primary data volume 104 and to the data protection system 106. The data protection system 106 manages the secondary data volume 108 and a copy of the secondary data volume 602 (hereinafter referred to as the “copy volume”). In operation, the data protection system 106 performs writes to the secondary data volume 108 as described above, and writes snapshot clones to the copy volume 602. The fault zone isolation between the secondary data volume 108 and the copy volume 602 is at a disk level.

FIG. 6B shows a system 610 that provides remote clone storage. The system 610 includes the host computer 102 connected directly to the primary data volume 104 and to the data protection system 106. The data protection system 106 manages the secondary data volume 108. A second data protection system 612 communicates directly and asynchronously with the data protection system 106 to receive the clones. The second data protection system 612 stores the clones on a third data volume 614. Both the second data protection system 612 and the third data volume 614 are located in a different fault zone from the rest of the system 610; the fault zone isolation in the system 610 is at the appliance level or the data center level.

FIG. 6C shows a system 620 that provides remote clone storage via a bunker appliance. The system 620 includes the host computer 102 connected directly to the primary data volume 104 and to the data protection system 106. The data protection system 106 manages the secondary data volume 108. A second data protection system 622 communicates directly with the data protection system 106 in a synchronous manner to receive the clones.

The second data protection system 622 stores the clones on a third data volume 624. The second data protection system 622 and the third data volume 624 comprise a bunker appliance 626, which is located in the same fault zone as the data protection system 106 and the secondary data volume 108. The purpose of the bunker appliance 626 is to provide a persistent buffer of data (the write log) that is guaranteed to eventually be copied to the remote node. Alternatively, the bunker appliance 626 can be located in a different fault zone form the data protection system 106 and the secondary data volume 108.

A third data protection system 630 communicates with the second data protection system 622 in an asynchronous manner. The third data protection system 630 stores clones received from the second data protection system 622 on a fourth data volume 632. The third data protection system 630 and the fourth data volume 632 comprise a remote node 634, which is located in a different fault zone from the rest of the system 620. The second data protection system 622 and the third data protection system 630 can communicate asynchronously because as long as the third data volume 624 remains intact, it is not critical that the data be transferred to the fourth data volume 632 within a specific time frame. The key point is that the data will be copied to the fourth data volume 632. It is noted that any copies from a secondary volume to a tertiary volume (in this instance, either the third data volume 624 and the fourth data volume 632) can be performed asynchronously. The writes are preferably performed asynchronously so that the multiple writes do not affect the writes to the primary volume (i.e., adds no latency to the writes), which must be synchronous.

While specific embodiments of the present invention have been shown and described, many modifications and variations could be made by one skilled in the art without departing from the scope of the invention. The above description serves to illustrate and not limit the particular invention in any way.

1. A method for adding redundancy to a continuous data protection system, comprising the steps of:
taking a snapshot of a primary volume at a specific point in time;
storing the snapshot on a secondary volume;
cloning the snapshot and storing the cloned snapshot on a third volume;
expiring the cloned snapshot.

2. The method according to claim 1, wherein the taking step is performed according to a retention policy.

3. The method according to claim 1, wherein the cloning step is performed according to a cloning policy.

4. The method according to claim 3, wherein the cloning policy is part of a retention policy.

5. The method according to claim 3, wherein the cloning policy specifies at least one of: a number of clones to be made, a frequency at which a clone is made, and a time period for retaining a clone.

6. The method according to claim 5, wherein the expiring step includes deleting the cloned snapshot at the end of the time period specified in the cloning policy.

7. The method according to claim 1, wherein the expiring step includes deleting the cloned snapshot at the same time as the snapshot.

8. The method according to claim 1, wherein the expiring step includes deleting the cloned snapshot at a different time than the snapshot.

9. The method according to claim 1, wherein the primary volume and the secondary volume are located within a first fault zone and the third volume is located in a second fault zone separate from the first fault zone.

10. A system for adding redundancy to a continuous data protection system, comprising:
snapshot means for taking a snapshot of a primary volume at a specific point in time;
storing means for storing said snapshot on a secondary volume;
cloning means for cloning said snapshot and storing said cloned snapshot on a third volume;
expiring means for expiring said cloned snapshot.

11. The system according to claim 10, wherein said snapshot means performs according to a retention policy.

12. The system according to claim 10, wherein said cloning means performs according to a cloning policy.

13. The system according to claim 12, wherein said cloning policy is part of a retention policy.

14. The system according to claim 12, wherein said cloning policy specifies at least one of: a number of clones to be made, a frequency at which a clone is made, and a time period for retaining a clone.

15. The system according to claim 14, wherein said expiring means includes deleting said cloned snapshot at the end of said time period specified in said cloning policy.

16. The system according to claim 10, wherein said expiring means includes deleting said cloned snapshot at the same time as said snapshot.

17. The system according to claim 10, wherein said expiring means includes deleting said cloned snapshot at a different time than said snapshot.

18. The system according to claim 10, wherein said primary volume and said secondary volume are located within a first fault zone and said third volume is located in a second fault zone separate from said first fault zone.

19. A method for managing a recovery point in a continuous data protection system, comprising the steps of:
setting a retention policy;
taking a snapshot of a primary volume according to the retention policy, the snapshot providing a recovery point on the primary volume;
storing the snapshot on a secondary volume;
expiring the snapshot according to the retention policy;
setting a cloning policy;
creating a clone of the snapshot according to the cloning policy;
storing the cloned snapshot on a third volume; and
expiring the cloned snapshot according to the cloning policy.

20. The method according to claim 19, wherein the cloning policy is part of the retention policy.

21. The method according to claim 19, wherein the cloned snapshot is expired at the same time as the snapshot.

22. The method according to claim 19, wherein the cloned snapshot is expired at a different time than the snapshot.

23. A system for managing a recovery point in a continuous data protection system, comprising:
first policy means;
snapshot means for taking a snapshot of a primary volume, said first policy means controlling said snapshot means;
first storing means for storing said snapshot on a secondary volume;
first expiring means for expiring said snapshot, said first policy means controlling said first expiring means;
second policy means;
cloning means for creating a clone of said snapshot, said second policy means controlling said cloning means;
second storing means for storing said cloned snapshot on a third volume; and
second expiring means for expiring said cloned snapshot, said second policy means controlling said second expiring means.

24. The system according to claim 23, wherein:
said first policy means includes a retention policy; and
said second policy means includes a cloning policy.

25. The system according to claim 23, wherein said second policy means is part of said first policy means.

26. A system for continuous data protection, comprising:
a host computer;
a first volume connected to said host computer, said first volume containing data to be protected;
a first data protection system connected to said host computer;
a second volume connected to said first data protection system, said second volume being a protected version of said first volume;
a second data protection system communicating with said first data protection system; and
a third volume connected to said second data protection system, said third volume being a copy of said second volume.

27. The system according to claim 26, wherein said first data protection system and said second data protection system communicate asynchronously.

28. The system according to claim 26, wherein said second data protection system and said third volume are located in a fault zone with said first data protection system and said second volume.

29. The system according to claim 26, wherein said second data protection system and said third volume are located in a fault zone separate from said first data protection system and said second volume.

30. The system according to claim 26, further comprising:
a third data protection system communicating with said second data protection system; and
a fourth volume connected to said third data protection system, said fourth volume being a copy of said third volume.

31. The system according to claim 30, wherein
said second data protection system communications with said first data protection system synchronously, whereby said third volume is a current copy of said second volume; and
said third data protection system communicates with said second data protection asynchronously.

32. The system according to claim 30, wherein
said second data protection system and said third volume are located in a first fault zone with said first data protection system and said second volume; and
said third data protection system and said fourth volume are located in a second fault zone, said second fault zone being separate from said first fault zone.

33. The system according to claim 30, wherein
said first data protection system and said second volume are located in a first fault zone;
said second data protection system and said third volume are located in a second fault zone, said second fault zone being separate from said first fault zone; and
said third data protection system and said fourth volume are located in a third fault zone, said third fault zone being separate from said first fault zone and said second fault zone.
